(19) United States
(12) Patent Application Publication
(10) Pub. No.: US 2015/0298563 A1
(43) Pub. Date: Oct. 22, 2015

(54) APPARATUS FOR CHARGING BATTERY AND METHOD THEREOF

(71) Applicant: HYUNDAI MOBIS CO., LTD., Seoul (KR)

(72) Inventor: Da Un JEONG, Yongin-Si (KR)

(73) Assignee: HYUNDAI MOBIS CO., LTD., Seoul (KR)

(21) Appl. No.: 14/689,622

(22) Filed: Apr. 17, 2015

(30) Foreign Application Priority Data
Apr. 22, 2014 (KR) 10-2014-0048134

(51) Int. Cl. B60L 11/18

(52) U.S. Cl. CPC B60L 11/1809; B60L 11/1861

(57) ABSTRACT

The present invention relates to a battery charging apparatus and a method thereof. The exemplary embodiment of the present invention provides a battery charging apparatus, including: a sub battery sensor which detects a charged state (state of charge) of a sub battery; a main battery sensor which detects a charged state of the main battery which is connected to the sub battery in parallel and calculates a value of a collective charged state of the battery using the charged state of the sub battery transmitted from the sub battery sensor and the charged state of the main battery; and an electric control unit (ECU) which controls charging of a battery including the sub battery and the main battery based on the collective charged state.

### CROSS-REFERENCE TO RELATED APPLICATIONS

This application claims priority under 35 U.S.C. §119 to Korean Patent Application No. 10-2014-0048134, filed on Apr. 22, 2014, in the Korean Intellectual Property Office, the disclosure of which is incorporated herein by reference in its entirety.

### TECHNICAL FIELD

The present invention relates to a battery charging apparatus and a method thereof, and more particularly, to an apparatus for charging a battery of a vehicle and a method thereof.

### BACKGROUND

An intelligent battery sensor (IBS) measures a current, a voltage, and a temperature of a battery to generate state information of the battery. The state information of the battery includes information related with a charging capacity of the battery and a lifespan of the battery. The state information of the battery is transmitted to an ECU in the vehicle and the ECU in the vehicle calculates a maximum energy which may be supplied by the battery when the vehicle is driven, based on the transmitted state information of the battery, and limits an energy which is unnecessarily consumed when a speed of the vehicle is reduced. As described above, the intelligent battery sensor is required to protect the battery from being overcharged and optimize a usage range of the battery.

FIG. 1 is a block diagram illustrating a configuration of a power generation control system including a general intelligent battery sensor.

Referring to FIG. 1, a general power generation control system includes an intelligent battery sensor (IBS) 110, an electric control unit (ECU) 120, and a power generation device 130. The intelligent battery sensor 110 of the general power generation control system detects a state of the battery including a temperature, a current, and a charged amount of the battery mounted in the vehicle and transmits the detected battery state to the ECU 120 as battery state information I1.

The ECU 120 generates a power generation command 12 based on the transmitted battery state information I1 and transmits the generated power generation command 12 to the power generation device 130.

The power generation device 130 charges the battery mounted in the vehicle in accordance with the transmitted power generation command 12.

FIG. 2 is a view illustrating a change of a battery voltage in accordance with a change of a vehicle speed.

Referring to FIG. 2, at a timing t1 when the vehicle starts being accelerated, the battery voltage starts decreasing. While the vehicle speed is increased (t1 to t2), the battery voltage is maintained at a decreased voltage V1. Thereafter, at a timing t3 when the vehicle speed is reduced, the battery voltage starts increasing. While the vehicle speed is reduced (t3 to t4), the battery voltage is maintained at an increased voltage V2.

FIGS. 3A and 3B are a circuit diagram illustrating a circuit configuration for controlling a battery voltage change illustrated in FIG. 2, in which FIG. 3A is a circuit diagram explaining a circuit operation while the vehicle speed is increased and FIG. 3B is a circuit diagram explaining a circuit operation while the vehicle speed is reduced.

Referring to 3A, a generator 21 does not charge a battery 23 while the vehicle speed is increased (0 to t2). Therefore, the voltage of the battery 23 is maintained at a decreased battery voltage V1. In contrasts, while the vehicle speed is reduced (t3 to t4), the generator 22 charges the battery 24. The battery voltage is maintained at an increased state by charging the battery using the generator 22.

Currently, in the vehicle, the electronic apparatuses such as a black box which requires to be supplied with power even when the vehicle is parked are designed. That is, even when the vehicle is parked, power of the battery may be continuously consumed. Therefore, when the vehicle is parked for a long time, the battery may be easily discharged. The discharged battery prevents a stable start of a vehicle, which causes inconvenience to drivers. In order to solve the problem, a method which adds a sub battery in the vehicle, in addition to a main battery is suggested.

However, even when the main battery is completely charged, the sub battery is not completely charged in many cases. For example, when two batteries are connected to each other but voltages of the batteries are not equal to each other, a current flows from a battery having a higher voltage to a battery having a lower voltage so that the voltages of two batteries are equal to each other.

Generally, the main battery of the vehicle is installed in an engine room which is close to the generator and the sub battery is mounted in a space of a trunk. In this case, the voltage of the main battery which is close to the generator is high, but the sub battery has a lower voltage than that of the main battery, due to its installation location. Further, the sub battery is charged slower than the main battery.

The intelligent battery sensor of the related art monitors only the charged amount of the main battery and transmits a power generation stop request to the ECU when the main battery is completely charged. Therefore, even though the sub battery is not completely charged, the generator stops charging the battery. For example, when the generation control is performed only using the charged state of the main battery and the intelligent battery sensor monitors that the main battery is completely charged and transmits the monitoring result to the ECU, the ECU transmits a power generation stop command to the generator.

However, the sub battery is not completely charged in some cases. When the sub battery is not completely charged, the main battery serves as a generator to charge the sub battery, which may lower performance of the vehicle battery.

### SUMMARY

The present invention has been made in an effort to provide a battery charging apparatus which collectively manages a sub battery and a main battery to completely charge the sub battery and the main battery and a method thereof.

An exemplary embodiment of the present invention provides an apparatus for charging a battery mounted in a vehicle, including: a sub battery sensor which detects a charged state (state of charge) of a sub battery; a main battery sensor which detects a charged state of the main battery which is connected to the sub battery in parallel and calculates a value of a collective charged state of the battery using the charged state of the sub battery transmitted from the sub battery sensor and the charged state of the main battery; and an electric control unit (ECU) which controls charging of a battery including the sub battery and the main battery based on the collective charged state.

The main battery sensor calculates a value of the collective charged state using the following equation.

Collective charged state=(remaining amount of main battery+remaining amount of sub battery)/(total capacity of main battery+total capacity of sub battery [Equation]

For example, the ECU compares the value of the collective charged state with a predetermined charging completion reference value and controls charging of the battery in accordance with the comparison result. When a value of the collective charged state is smaller than the charging completion reference value, the ECU controls to charge the battery.

As another example, the ECU controls the charging of the battery in consideration of a value of the collective charged state and a driving state of the vehicle, when the driving state of the vehicle is a speed reducing driving state, controls the charging of the battery to increase the value of the collective charged state, and when the driving state of the vehicle is an accelerating state, controls to stop the charging of the battery.

The sub battery sensor adds up the charged current and a discharged current of the sub battery as the time elapses to detect the charged state of the sub battery and is connected to the main battery sensor through local interconnect network (LIN) communication.

Another exemplary embodiment of the present invention provides a method for charging a battery including a sub battery and a main battery mounted in the vehicle, the method including: monitoring a charged state (State of Charge) of the sub battery and a charged state of the main battery which is connected to the sub battery in parallel; calculating a value of a collective charged state obtained by combining the charged state of the sub battery and the charged state of the main battery; and controlling the charging of the battery based on the value of the collective battery charged state.

In the calculating, a value of the collective charged state is calculated using the following equation.

Collective charged state=(remaining amount of main battery+remaining amount of sub battery)/(total capacity of main battery+total capacity of sub battery [Equation]

As an example, in the controlling, the value of the collective charged state is compared with a predetermined charging completion reference value and the battery is controlled to be charged in accordance with the comparison result, the controlling includes comparing the value of the collective charged state with the predetermined charging completion reference value and when the value of the collective charged state is smaller than the charging completion reference value as the comparison result, controlling to charge the battery; and when a value of the collective charged state is equal to or larger than the charging completion reference value as a comparison result, controlling the battery so as not to be charged.

As another example, the controlling includes controlling the charging of the battery in consideration of a value of the collective charged state and a driving state of the vehicle, when the driving state of the vehicle is a speed reducing driving state, controlling the charging of the battery to increase the value of the collective charged state, and when the driving state of the vehicle is an accelerating state, controlling to stop the charging of the battery.

The charged state of the sub battery is obtained by adding the charged current and the discharged current of the sub battery as the time elapses.

According to the present invention, the power generation is controlled in consideration of the charged state of the sub battery, which may prevent the performance of the main battery from being lowered.

The charged state of the sub battery and the main battery which are connected in parallel is collectively managed using an intelligent battery sensor, so that the sub battery and the main battery are completely charged.

### BRIEF DESCRIPTION OF THE DRAWINGS

FIG. 1 is a view illustrating a configuration of a power generation control system including a general intelligent battery sensor.

FIG. 2 is a view illustrating a change of a battery voltage in accordance with a general change of a vehicle speed.

FIGS. 3A and 3B are a diagram illustrating a simple power generation control circuit for controlling a battery voltage change illustrated in FIG. 2.

FIG. 4 is a block diagram of an intelligent battery sensor according to an exemplary embodiment of the present invention.

FIG. 5 is a block diagram of a battery charging system according to an exemplary embodiment of the present invention.

FIG. 6 is a block diagram illustrating each configuration of the sub battery sensor and a main battery sensor illustrated in FIG. 5 in detail.

FIG. 7 is a flow chart of a signal of a battery charging method according to an exemplary embodiment of the present invention.

FIG. 8 is a block diagram illustrating a computer system for the present invention.

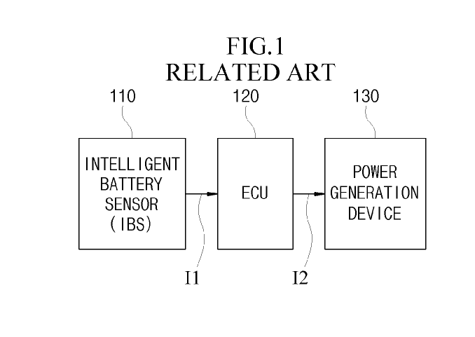

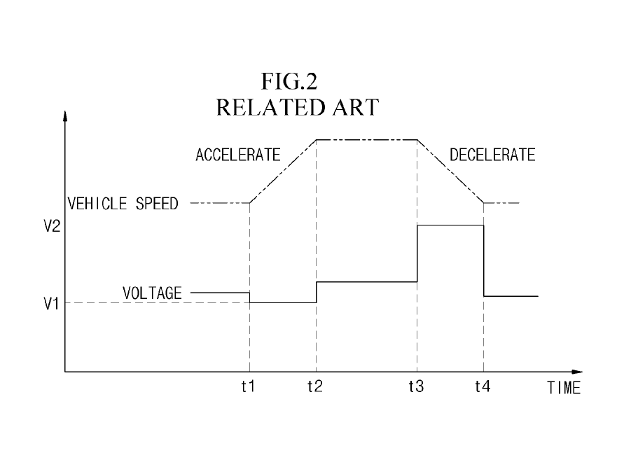

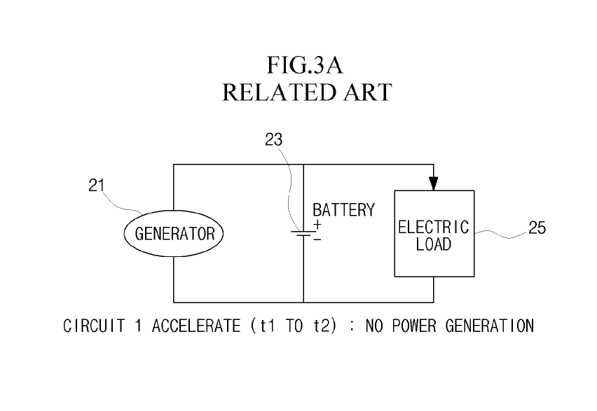

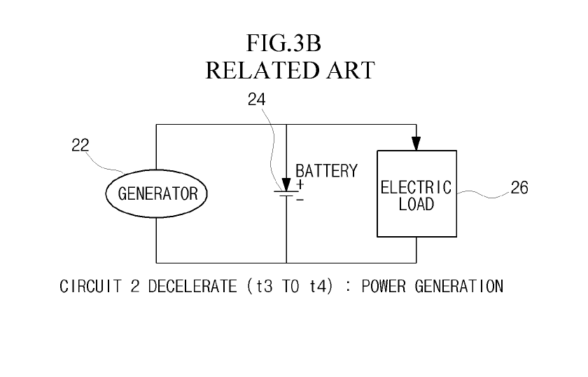

### DETAILED DESCRIPTION OF THE EMBODIMENTS

Advantages and characteristics of the present invention and a method of achieving the advantages and characteristics will be clear by referring to exemplary embodiments described below in detail together with the accompanying drawings. However, the present invention is not limited to exemplary embodiment disclosed hereinafter but will be implemented in various forms. The exemplary embodiments introduced herein are provided to make disclosed contents thorough and complete and sufficiently transfer the spirit of the present invention to those skilled in the art. Therefore, the present invention will be defined only by the scope of the appended claims. Meanwhile, terminologies used in the present specificationare to explain exemplary embodiments rather than limiting the present invention. Unless particularly stated otherwise in the present specification, a singular form also includes a plural form.

Prior to description, an intelligent battery sensor which is applicable to the present invention will be described in brief. The brief description of the intelligent battery sensor helps to understand the present specification so that when the description does not clearly limit, it should be noted that the description is not used to limit the technical spirit of the present invention.

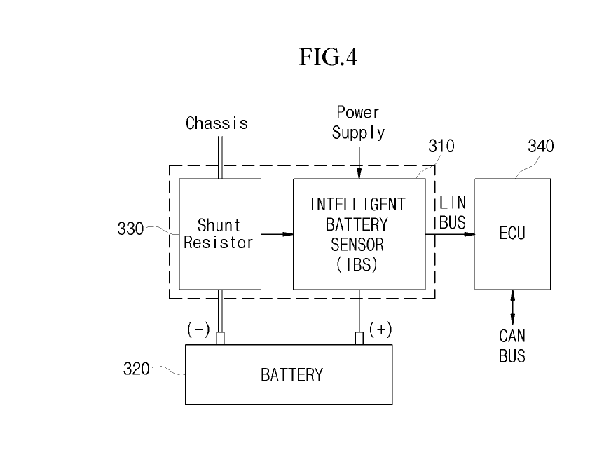

FIG. 4 is a block diagram of an intelligent battery sensor which is applicable to the present invention.

Referring to FIG. 4, the intelligent battery sensor 310 is connected to a negative terminal of the battery 320 to periodically monitor a current, a voltage, and a temperature of the battery. Next, the intelligent battery sensor 310 detects a state of the battery 320 based on monitored current, voltage, and temperature data of the battery.

The intelligent battery sensor 310 transmits the detected battery state information to the electric control unit (ECU) 340. Here, the battery state information includes a battery charged state (a state of charge: SoC), a battery time-won state (a state of health, SoH), a battery starting function (state of function, SoF), and a battery internal temperature.

The battery 320 supplies a power to the vehicle.

A shunt resistor 330 is a resistor which measures a current input to the battery sensor 310 and connects the intelligent battery sensor 310 and the negative terminal of the battery 320.

The intelligent battery sensor 310 measures a current which flows the shunt resistor 330 and a voltage difference between both ends of the shunt resistor 330 to monitor the state of the battery and transmits a monitoring result to the ECU 340 through network communication in the vehicle. Here, the network communication in the vehicle may be any one of a local interconnect network (LIN), a controller area network (CAN), and a media oriented systems transport (MOST) communication. Even though not specifically limited, in the following embodiment, the network communication in the vehicle is assumed as the local interconnect network (LIN).

The ECU 340 generates a charging command of the battery 320 based on the transmitted battery state and transmits the charging command to the power generation device.

In the meantime, in the present invention, in order to completely charge the sub battery mounted in the vehicle, a sub battery sensor which monitors a charged state of the sub battery is designed and the sub battery sensor and the main battery sensor are connected to each other by the network communication in the vehicle.

The main battery sensor may receive the state information of the sub battery from the sub battery sensor through the network communication in the vehicle, so that the main battery sensor may collectively manage not only the main battery but also the sub battery. Therefore, not only the main battery, but also the sub battery may be completely charged.

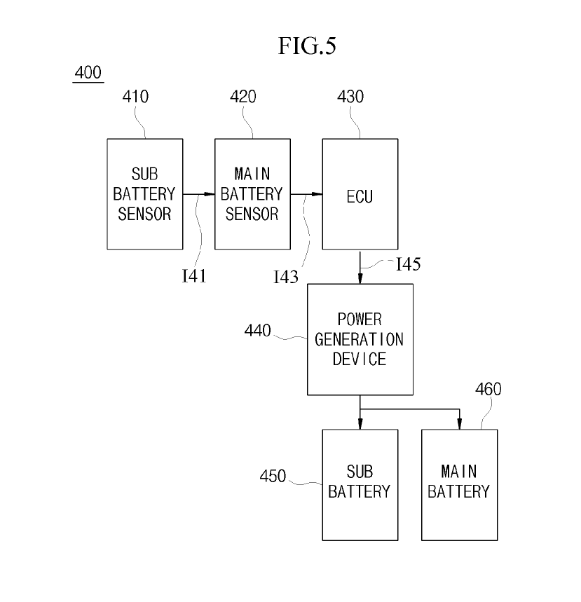

The battery charging system according to the exemplary embodiment of the present invention may be configured as illustrated in FIG. 5, for the above-described operation. FIG. 5 is a block diagram of a battery charging system according to an exemplary embodiment of the present invention.

The battery charging system 400 according to the exemplary embodiment of the present invention includes a sub battery sensor 410, a main battery sensor 420, an ECU 430, a power generation device 440, a sub battery 450, and a main battery 460.

The sub battery sensor 410 detects the charged state of the sub battery. For example, the sub battery sensor 410 monitors the state of the sub battery and detects the charged state of the sub battery through the monitored state information. The detected charged state information 141 of the sub battery is transmitted to the main battery sensor 420 through the LIN communication.

The main battery sensor 420 receives the sub battery charged state information 141 through the LIN communication and generates battery collective charged state information 145 obtained by combining and monitoring the received sub battery charged state information and a main battery charged state. Here, the monitored battery collective charged state is a charged state obtained by considering both the charged state of the sub battery and the charged state of the main battery.

The main battery sensor 420 transmits the generated collective charged state information 143 to the ECU 430.

The ECU 430 generates a battery charging command in accordance with the transmitted collective charged state information 143. The ECU 430 transmits the generated battery charging command 145 to the power generation device 440.

The power generation device 440 controls both the sub battery 450 and the main battery 460 to be charged in accordance with the transmitted battery charging command 145.

In the exemplary embodiment, even though the main battery is completely charged, when the sub battery is not charged, the ECU 430 recognizes that the collective charged state is low. In the specification, the collective charged state is interpreted as a collective charged amount and defined as a charged amount obtained by considering both the charged amount of the sub battery and the charged amount of the main battery. Such a collective charged amount will be described in detail by following Equation 1.

When the recognized collective charged amount is lower than a predetermined completely charged reference value, the ECU 430 generates the battery charging command 145.

The power generation device 440 applies the charged current to the battery in accordance with the transmitted battery charging command. When the main battery 460 is completely charged, a difference between the voltage of the main battery 460 and the voltage of the power generating device 440 is small. Therefore, a small amount of charged current transmitted from the power generation device 440 flows in the main battery 460.

In contrast, since the difference between the voltage of the sub battery 450 and the voltage of the power generation device 450 is large, most of the charged current supplied from the power generation device 440 is applied to the sub battery 450, so that the sub battery 450 is charged.

As described above, the battery charging system according to the exemplary embodiment of the present invention controls to charge the battery using the collective charged state including the sub battery charged state, so that the sub battery may be completely charged without lowering the performance of the main battery.

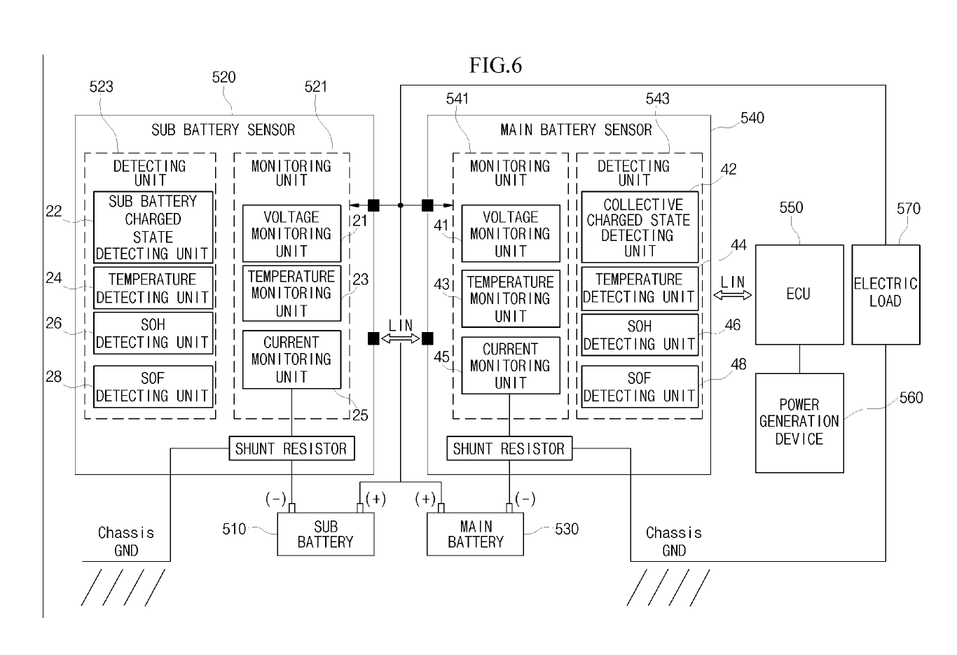

FIG. 6 is a block diagram illustrating each configuration of the sub battery sensor and the main battery sensor illustrated in FIG. 5 in detail.

Referring to FIG. 6, the sub battery sensor 520 of the battery charging system which collectively manages the charged amount of the sub battery detects the charged state of the sub battery 510. To this end, the sub battery sensor 520 includes a monitoring unit 521 and a detecting unit 523.

The monitoring unit 521 monitors the state of the sub battery 510. For example, the monitoring unit 521 monitors a voltage, a temperature, and a current indicating the state of the sub battery. To this end, the monitoring unit 521 includes a voltage monitoring unit 21, a temperature monitoring unit 23, and a current monitoring unit 25. The monitoring unit 521 monitors the state of the sub battery and transmits monitored charged state information of the sub battery 510 to the detecting unit 523.

The detecting unit 523 detects the state of the sub battery 510 including the charged state of the sub battery 510 using the transmitted state information of the sub battery 510. To this end, the detecting unit 523 includes a sub battery charged state detecting unit 22, a temperature detecting unit 24, a SoH detecting unit 26, and a SoF detecting unit 28.

The sub battery temperature detecting unit 24 receives temperature information of the sub battery 510 to detect temperature of the sub battery 510. The SoH detecting unit 26 receives state information of the sub battery 510 to digitize the time-worn state of the sub battery 510. Here, the battery time-worn state means a life span of the battery. The SoF detecting unit 208 receives the state information of the sub battery 510 to digitize a starting ability of the sub battery. The starting ability of the sub battery is an ability to supply the power by the sub battery 510 to start the vehicle.

In the exemplary embodiment, the sub battery charged state detecting unit 22 receives the monitored state information of the sub battery to detect the state of charge (SoC) of the sub battery. The state of charge (SoC) may be represented by calculating a current remaining amount with respect to the total battery capacity as a percentage. A represented range of the state of charge (SoC) is 0% to 100% and 100% indicates a completely charged state.

The sub battery charged state detecting unit 22 detects the state of charge (SoC) of the sub battery using charged current and discharged current information of the sub battery 510. For example, the sub battery charged state detecting unit 22 adds up the charged current and the discharged current of the sub battery 510 as the time elapses to obtain the state of charge (SoC) of the sub battery. The sub battery charged state detecting unit 22 transmits the added charged state information of the sub battery 510 to the main battery sensor 540.

The main battery sensor 540 receives the charged state information of the sub battery 510 to calculate a collective charged state in which the charged state of the sub battery 510 and the charged state of the main battery 530 are combined. To this end, the main battery sensor 540 includes a monitoring unit 541 and a detecting unit 543.

The monitoring unit 541 monitors the state of the main battery 530. For example, the monitoring unit 541 of the main battery sensor 540 monitors a temperature, a current, and a voltage of the main battery. To this end, the monitoring unit 541 includes a voltage monitoring unit 41, a temperature monitoring unit 43, and a current monitoring unit 45.

The detecting unit 543 of the main battery sensor 540 detects a collective charged state indicating the charged state of the main battery 530 and the charged state of the sub battery 510. To this end, the detecting unit 543 of the main battery sensor 540 includes a collective charged state detecting unit 42, a temperature detecting unit 44, a SoH detecting unit 46, and a SoF detecting unit 48. The configuration included in the detecting unit 543 of the main battery sensor 540 performs the same function as that of the configuration included in the detecting unit 523 of the sub battery sensor 520. Therefore, the detailed description thereof will be replaced with the description of the detecting unit 523 of the sub battery sensor 520.

In the exemplary embodiment of the present invention, the collective charged state detecting unit 42 detects a collective charged state (SoC) obtained by considering the charged state of the sub battery 510 and the charged state of the main battery 530.

The collective charged state includes both the charged state of the sub battery 510 and the charged state of the main battery 530. For example, the main battery sensor 540 detects the collective charged state SoC by a ratio of a result of adding the charged amount of the sub battery 510 and the charged amount of the main body with respect to a result of adding a total capacity of the sub battery and a total capacity of the main battery. In the exemplary embodiment, the collective charged state SoC may be represented by Equation 1.

Collective charged state=(remaining amount of main battery+remaining amount of sub battery)/(total capacity of main battery+total capacity of sub battery) [Equation 1]

The collective charged state detecting unit 42 transmits the collective charged state obtained through Equation 1 to the ECU 550.

The ECU 550 generates a charging command in accordance with the transmitted collective charged state. For example, the ECU 550 compares the transmitted collective charged state with a completely charged reference value. The ECU 550 generates a battery charging command to charge at least any one of the sub battery 510 and the main battery 530 in accordance with the comparison result. For example, the collective charged state (SoC) is 30% which is smaller than the completely charged reference value (80%), the ECU 550 generates a battery charging command.

In another exemplary embodiment, the ECU 550 generates the battery charging command based on the total charged state transmitted from the main battery sensor 540 and driving situation information. For example, the ECU 550 applies a weight to the total charged state and the driving situation information to generate the charging command.

In consideration of the vehicle driving situation information, when the vehicle drives at a reduced speed, even though the collective charged state is larger than the completely charged reference value, the ECU 550 generates the charging command. For example, even when the collective charged state is 85% and the completely charged reference value is 80%, when the vehicle is driven at a reduced speed, the ECU 550 generates a charging command to increase the collective charged state.

In contrast, when the vehicle is accelerated, even though the collective charged state (SoC) is smaller than the completely charged reference value, the ECU 550 does not generate the charging command. For example, even though the collective charged state is 50% and the completely charged reference value is 80%, the ECU does not generate the charging command to increase the collective charged state while the vehicle is accelerated.

The example of the ECU 550 of generating the charging command just mentions an exemplary embodiment of the present invention, but various embodiments may be deducted by a weight for the change of the vehicle speed and a weight for the collective charged state.

The ECU 550 transmits the generated charging command to the power generation device 560. An engine controller or a body control module (BCM) also generates the charging command.

The power generation device 560 charges the sub battery 510 and the main battery 530 in accordance with the charging command. The power generation device 560 includes an alternator, a start motor, and an engine.

The electric load 570 is various electronic control devices of the vehicle.

As described above, the battery charging system according to the exemplary embodiment collectively manages the charged state of the sub battery 510 to completely charge the sub battery 510 without lowering the performance of the main battery 530.

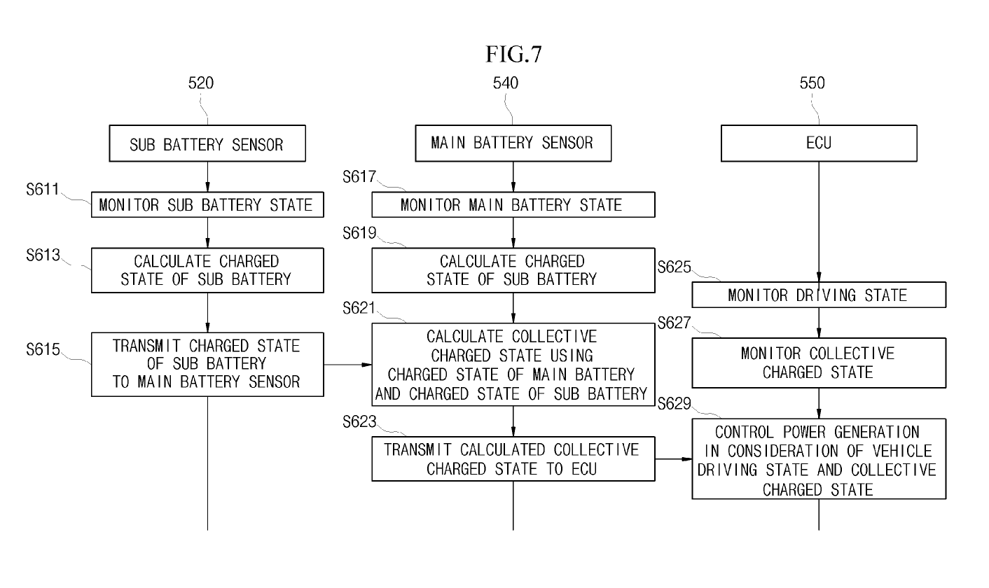

FIG. 7 is a flow chart of a signal of a battery charging method according to an exemplary embodiment of the present invention.

The sub battery sensor 520 monitors the sub battery 510 state in step S611. Here, the sub battery state which is monitored by the sub battery sensor 520 includes a temperature, a voltage, and a current of the sub battery 510.

The sub battery sensor 520 calculates a charged state of the sub battery 510 using the monitoring result of step S611 in step S613. For example, the sub battery sensor 520 adds up the charged current and the discharged current as the time elapses to obtain the charged state of the sub battery 510. Here, the charged state (state of charge, SoC) is data obtained by digitizing the charged state of the battery. For example, the state of charge (SoC) may be a value obtained by calculating a current remaining amount with respect to the total battery capacity as a percentage.

The value of the sub battery charged state calculated in the sub battery sensor 520 is transmitted to the main battery sensor 540 in step S615. Here, the sub battery sensor 520 and the main battery sensor 540 may share the battery charged state information through the LIN (local interconnect network) communication.

The main battery sensor 540 monitors the charged state of the main battery 530 in order to calculate the collective charged state in step S617. In this case, the charged state of the main battery 530 may be obtained by the same method as the method of monitoring the charged state of the sub battery 510 in step S611.

The main battery charged state is calculated using the charged state of the main battery 530 monitored in the main battery sensor 540 in step S619. In this case, a method of calculating the charged state of the main battery 530 may be the same as the method of calculating the charged state of the sub battery 510 in step S613.

The main battery sensor 540 calculates a collective charged state including the calculated main battery charged state and the charged state of the sub battery 510 received in step S615 in step S621. For example, the main battery sensor 540 may calculate the collective charged state (SoC) of the battery using Equation 1.

The main battery sensor 540 transmits the value of the calculated collective charged state to the ECU 550 in step S623.

The ECU 550 monitors the driving state of the vehicle in step S625. For example, the ECU 550 monitors the speed, a speed variation, and an engine state of the vehicle.

The ECU 550 monitors the collective charged state received in step S623.

The ECU 550 controls the power generation device 560 for charging the battery of the vehicle using the driving state and the collective charged state monitored in step S625 and step S627 in step S629. In this case, the ECU 550 controls the power generation device 560 to charge the battery based on the vehicle driving state and the collectively charged state of the battery.

In some exemplary embodiments, when the charged states of the sub battery 510 and the main battery 530 are combined to control the power generation, if the sub battery 510 is not charged, regardless of the charged state of the main battery 530, the collective charged state is calculated to be low. Therefore, the ECU 550 transmits a power generating command to increase the collective charged state to the power generation device 560.

The power generation device 560 applies the charged current to the battery in accordance with the transmitted battery charging command. When the main battery 530 is completely charged, the difference between the voltage of the main battery 530 and a voltage of the power generating device 560 is small. Therefore, a small amount of charged current transmitted from the power generation device 560 flows in the main battery 530.

In contrast, since the difference between the voltage of the sub battery 510 and the voltage of the power generation device 560 is large, most of the charged current supplied from the power generation device 560 is applied to the sub battery 510, so that the sub battery 510 is charged.

When the sub battery 510 is completely charged, the collective charged state is larger than the completely charged reference value. By doing this, the main battery sensor 540 transmits a charging completion signal to the ECU 550. The ECU 550 generates the power generation stopping command in accordance with the transmitted charging completion signal. Thereafter, the ECU 550 transmits the generated power generation stopping command to the power generation device 560. The battery charging completion reference value which determines the power generation control may vary depending on the vehicle or the battery.

As described above, the battery charging system according to the exemplary embodiment of the present invention controls to charge the battery using the collective charged state including the sub battery charged state, so that the sub battery may be completely charged without lowering the performance of the main battery.

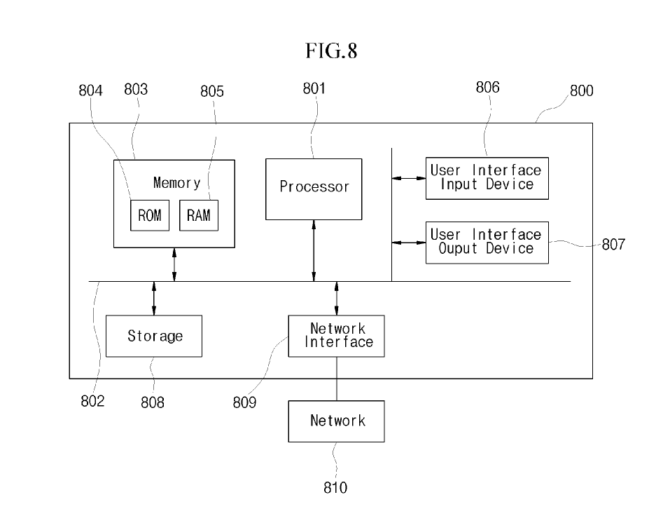

An embodiment of the present invention may be implemented in a computer system, e.g., as a computer readable medium. As shown in in FIG. 8, a computer system 800 may include one or more of a processor 801, a memory 803, a user input device 806, a user output device 807, and a storage 808, each of which communicates through a bus 802. The computer system 800 may also include a network interface 809 that is coupled to a network 810. The processor 801 may be a central processing unit (CPU) or a semiconductor device that executes processing instructions stored in the memory 803 and/or the storage 808. The memory 803 and the storage 808 may include various forms of volatile or non-volatile storage media. For example, the memory may include a read-only memory (ROM) 804 and a random access memory (RAM) 805.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

It will be appreciated by those skilled in the art to which the present invention pertains as described above that the present invention may be implemented into other specific forms without departing from the technical spirit thereof or essential characteristics. Thus, it is to be appreciated that the embodiments described above are intended to be illustrative in every sense, and not restrictive. The scope of the present invention is represented by the claims to be described below rather than the detailed description, and it is to be interpreted that the claims and all the changes or modified forms derived from the equivalents thereof come within the scope of the present invention.

What is claimed is:

1. A battery charging apparatus, comprising:
a sub battery sensor which detects a charged state (state of charge) of a sub battery;
a main battery sensor which detects a charged state of the main battery which is connected to the sub battery in parallel and calculates a value of a collective charged state of the battery using the charged state of the sub battery transmitted from the sub battery sensor and the charged state of the main battery; and
an electric control unit (ECU) which controls charging of a battery including the sub battery and the main battery based on the collective charged state.

2. The battery charging apparatus of claim 1, wherein the main battery sensor calculates a value of the collective charged state using the following Equation:
Collective charged state=(remaining amount of main battery+remaining amount of sub battery)/(total capacity of main battery+total capacity of sub battery).

3. The battery charging apparatus of claim 2, wherein the ECU compares the value of the collective charged state with a predetermined charging completion reference value and controls charging of the battery in accordance with the comparison result.

4. The battery charging apparatus of claim 3, wherein when a value of the collective charged state is smaller than the charging completion reference value, the ECU controls to charge the battery.

5. The battery charging apparatus of claim 2, wherein the ECU controls the charging of the battery in consideration of a value of the collective charged state and a driving state of the vehicle.

6. The battery charging apparatus of claim 5, wherein when the driving state of the vehicle is a speed reducing driving state, the ECU controls the charging of the battery to increase the value of the collective charged state, and when the driving state of the vehicle is an accelerating state, the ECU controls to stop the charging of the battery.

7. The battery charging apparatus of claim 1, wherein the sub battery sensor adds up the charged current and a discharged current of the sub battery as the time elapses to detect the charged state of the sub battery.

8. The battery charging apparatus of claim 1, wherein the sub battery sensor is connected to the main battery sensor through local interconnect network (LIN) communication.

9. A method for charging a battery including a sub battery and a main battery, the method comprising:
monitoring a charged state (State of Charge) of the sub battery and a charged state of the main battery which is connected to the sub battery in parallel;
calculating a value of a collective charged state obtained by combining the charged state of the sub battery and the charged state of the main battery; and
controlling the charging of the battery based on a value of the collective charged state.

10. The method of claim 9, wherein in the calculating, the value of the collective charged state is calculated using the following equation:
Collective charged state=(remaining amount of main battery+remaining amount of sub battery)/(total capacity of main battery+total capacity of sub battery.

11. The method of claim 10, wherein the controlling includes comparing the value of the collective charged state with a predetermined charging completion reference value and controlling to charge the battery in accordance with the comparison result.

12. The method of claim 11, wherein the controlling includes:
comparing the value of the collective charged state with the predetermined charging completion reference value and when the value of the collective charged state is smaller than the charging completion reference value as a comparison result, controlling to charge the battery; and
when a value of the collective charged state is equal to or larger than the charging completion reference value as a comparison result, controlling the battery so as not to be charged.

13. The method of claim 10, wherein the controlling includes controlling the charging of the battery in consideration of a value of the collective charged state and a driving state of the vehicle.

14. The method of claim 13, wherein the controlling includes:
when the driving state of the vehicle is a speed reducing driving state, controlling the charging of the battery to increase the value of the collective charged state, and
when the driving state of the vehicle is an accelerating state, controlling to stop the charging of the battery.

15. The method of claim 9, wherein the charged state of the sub battery is obtained by adding the charged current and the discharged current of the sub battery as the time elapses.
